(19) United States
(12) Patent Application Publication
(10) Pub. No.: US 2009/0254475 A1
(43) Pub. Date: Oct. 8, 2009

(54) PREDICTION MARKET MAKING METHOD AND APPARATUS

(75) Inventors: David Pennock, Monroe Township, NJ (US); Yiling Chen, Jersey City, NJ (US); Sharad Chandra Goel, New York, NY (US)

Correspondence Address: YAHOO! INC.;C/O Ostrow Kaufman & Frankl LLP, The Chrysler Building, 405 Lexington Avenue, 62nd Floor, NEW YORK, NY, 10174, US

(73) Assignee: Yahoo! Inc., Sunnyvale, CA (US)

(21) Appl. No.: 12/061,062

(22) Filed: Apr. 2, 2008

(51) Int. Cl. G06Q 30/00; G06Q 20/00

(52) U.S. Cl. 705/39; 705/1

(57) ABSTRACT

Generally, a method and apparatus for making a prediction-based market including unconventional prediction options to market participants includes determining a prediction framework that includes a plurality of conditional scenarios. The method and apparatus includes calculating realization odds for each of the conditional scenarios using an approximation calculation technique and via an interface, receiving a plurality of predictions associated with selected conditional scenarios, each prediction having an associated value and building the prediction-based market using the predictor. The method and apparatus further includes updating realization odds for each of the conditional scenarios in the prediction framework using the approximation calculation technique and settling the predictions based at least on the updated realization odds.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### FIELD OF THE INVENTION

The present invention relates generally to prediction systems and more specifically to making a market for predictions based on using approximate calculations to allow unrestricted prediction options for market participants and including dynamic realization odd calculations within the active market.

### BACKGROUND OF THE INVENTION

In existing prediction systems, users are presented with standardized or predetermined prediction options. For example, one type of prediction system is an online wagering system, for example placing a wager on a sporting event. Existing wagering systems allow a user to place a wager on who will win the sporting event. These systems may be manual operations, such as a central location that takes user bets and settles the accounts, for example, a Casino.

These existing systems are tied to conventional and restricted betting options on the basis of logistics involved in predictability. Concurrent with prediction options are the corresponding odds for the occurrence of possible predictable outcomes. The ability to calculate odds or the likelihood of various outcomes significantly restricts the available prediction options. Using the example of a wager on a sporting event, the selection of a particular winner and a possible point difference is the generally available option. This significantly reduces the ability of a user to place a variety of wagers or make varying levels of predictions; it also significantly reduces the scope of a prediction market by limiting the variety and possibly quantity of predictions.

Combinatorial markets, by contrast, offer a significantly large variety of user options. A prediction market is a betting intermediary designed to aggregate opinions about events of particular interest or importance. For example, Intrade.com moderates bets on whether avian flu will hit the United States, and the Iowa Electronic Market (IEM) offers odds on presidential hopefuls. Market prices reflect a stable consensus of a large number of opinions about the likelihood of given events.

Betting intermediaries abound, from Las Vegas to Wall Street, yet nearly all operate in a similar manner. In particular, each bet type is managed independently, even when the bets are logically related. For example, stock options with different strike prices are traded in separate streams. In contrast, combinatorial markets propagate information appropriately across logically-related bets. Thus, these mechanisms have the potential to both collect more information and process that information more fully than standard mechanisms. This often requires, however, maintaining a probability distribution over a set that is exponentially larger than the number of base bets.

Accordingly, there exists a need for making a prediction-based market including unconventional prediction options to market participants.

### SUMMARY OF THE INVENTION

Generally, a method and apparatus for making a prediction-based market including unconventional prediction options to market participants includes determining a prediction framework that includes a plurality of conditional scenarios. The method and apparatus includes calculating realization odds for a given one of the conditional scenarios using an approximation calculation technique and via an interface, receiving a plurality of predictions associated with selected conditional scenarios, a given prediction having an associated value and building the prediction-based market using the predictor. The method and apparatus further includes updating realization odds for a given one of the conditional scenarios in the prediction framework using the approximation calculation technique and settling the predictions based at least on the updated realization odds.

Generally, with n competing teams, the outcome space is of size 2ⁿ⁻¹. The general pricing problem for tournaments is #P-hard, and thus can derive a polynomial-time algorithm when bet types are appropriately restricted. This is one example of a tractable market-maker driven combinatorial market. In exemplary betting language, agents may buy and sell assets of the form “team i wins game k”, and may also trade in conditional assets of the form “team i wins game k given that they make it to that game” and “team i beats team j given that they face off”.

Although these are arguably natural bets to place, the expressiveness of the language has the surprising side effect of introducing dependencies between games which are considered to be independent. For example, it is possible in this language to have a market distribution in which the winners of first round games are not independent of one another. This phenomenon relates to results on the impossibility of preserving independence in an aggregate distribution. Typical independent relationships are restored based on predictions or wagers of the form team i beats team j given that they face off against each other.

In typical applications, queries are made to the network to compute conditional probabilities under a fixed distribution. The method and apparatus uses the results of these queries to iteratively update the Bayesian network itself so as to mirror the evolving market distribution. A surprising feature of this representation is that network edges are necessarily oriented in the opposite direction suggested by the usual understanding of causality in tournaments. For example, instead of conditioning the distribution of second round games on the results of first round games, conditioning may be made on the results of third round games.

### BRIEF DESCRIPTION OF THE DRAWINGS

The invention is illustrated in the figures of the accompanying drawings which are meant to be exemplary and not limiting, in which like references are intended to refer to like or corresponding parts, and in which:

FIG. 1 illustrates a block diagram of a computing system providing a prediction-based market including unconventional predict options to market participants according to one embodiment of the present invention;

FIG. 2 illustrates a processing environment for providing a prediction-based market including unconventional predict options to market participants according to one embodiment of the present invention;

FIG. 3 illustrates a flowchart of a method for making a prediction-based market including unconventional prediction options to market participants according to one embodiment of the present invention;

FIGS. 4-7 illustrate exemplary screenshots of a user interface and interactive display for prediction-based marketing allowing market participants to make unconditional predictions according to one embodiment of the present invention; and

FIGS. 8-9 illustrate graphical displays of Bayesian networks for tournaments according to one embodiment of the present invention.

### DETAILED DESCRIPTION OF THE INVENTION

In the following description of the embodiments of the invention, reference is made to the accompanying drawings that form a part hereof, and in which is shown by way of illustration exemplary embodiments in which the invention may be practiced. It is to be understood that other embodiments may be utilized and structural changes may be made without departing from the scope of the present invention.

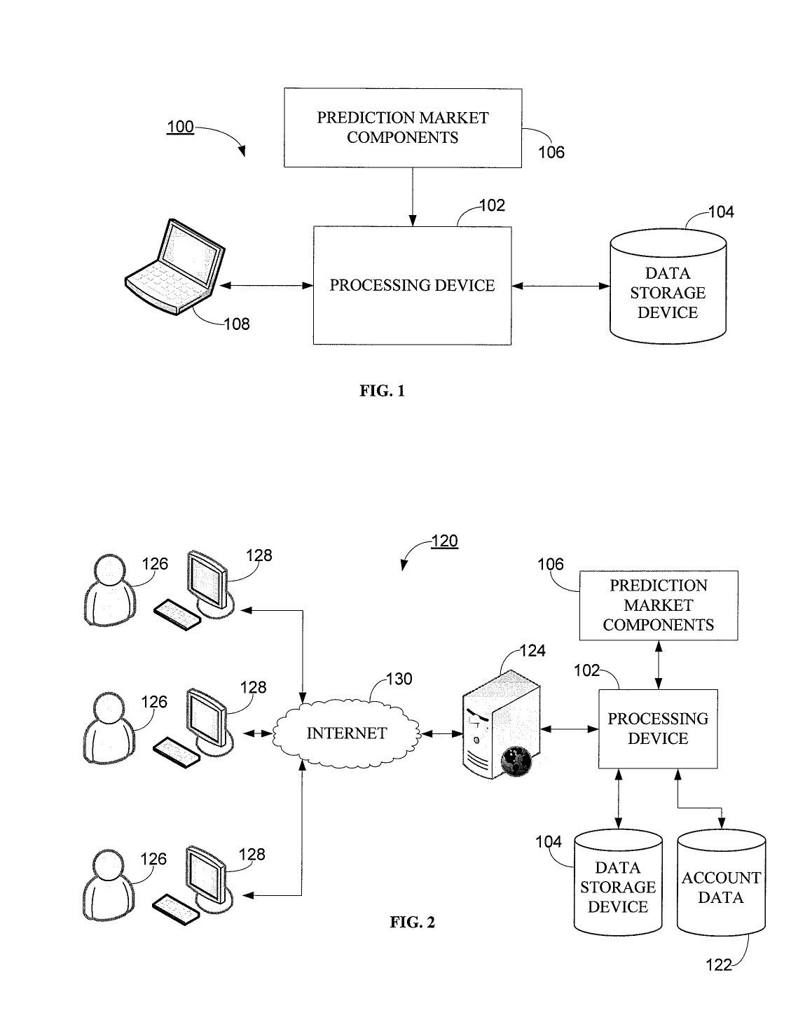

FIG. 1 illustrates an apparatus 100 that includes a processing device 102, a data storage device 104, prediction market components 106 and a computing device 108. The processing device 102 may be one or more processing elements operative to perform processing operations in response to executable instructions 110 received from the data storage device 104. The processing device 102 is illustrated as a single element, but may be composed of any number of processing elements in a central or in a distributed processing environment.

The data storage device 104 may be one or more data storage locations operative to store the executable instructions 110 therein. The prediction market components 106 may be data elements stored in one or more memory locations. The market components 106 may include aspects to the prediction market generated by the processing device 102 as described in further detail below. The prediction market components include, for example, factors used in realization odd calculations, such as for example the odds of an occurrence of a conditional event.

The computing device 108 represents an interface for users to access the processing device 102 and submit predictions or otherwise interact with the prediction markets. Interactions may include researching market factors such as current odds for prediction events, viewing the market itself, watching prediction or wagers, placing predictions, settling accounts, among other things.

FIG. 2 illustrates another embodiment, this system of a system 120, which includes the processing device 102, the prediction market components 106, the data storage device 104, an account data storage device 122, a server processing device 124, a plurality of users 126, user computers 128 and a network connection 130, such as the Internet.

The account data storage device 122 may be one or more suitable storage devices having account information stored therein, such as account information relating to user accounts for the users 126. This account information may include personal information for record keeping purposes, may also include credit or other value indicators, such as points or other types of rewarding mechanisms for prediction operations described herein. It is also recognized that the account data 122 may include information for accessing other types of credit, such as for example information on how to access a bank account or a credit card account in the event predictions are performed using financial instruments. It is also recognized that the account data 122, as well as processing instructions within the processing device 102 can be programmed for legal and regulatory compliance with any regional or jurisdictional governing laws or regulations, such as for example laws governing gambling or wagering or regulations governing security-based predictions, if applicable.

The server processing device 124 may be any suitable server operative to provide interface to the user computers 128 via the network connection 130, herein referred to as the Internet but generally recognized as being any suitable type of network and not expressly restricted to an Internet connection. The server processing device 124 allows for the prediction operations of the processing device 102 to be visually communicated to the users 126 and handles corresponding interaction operations to facilitate user prediction operations.

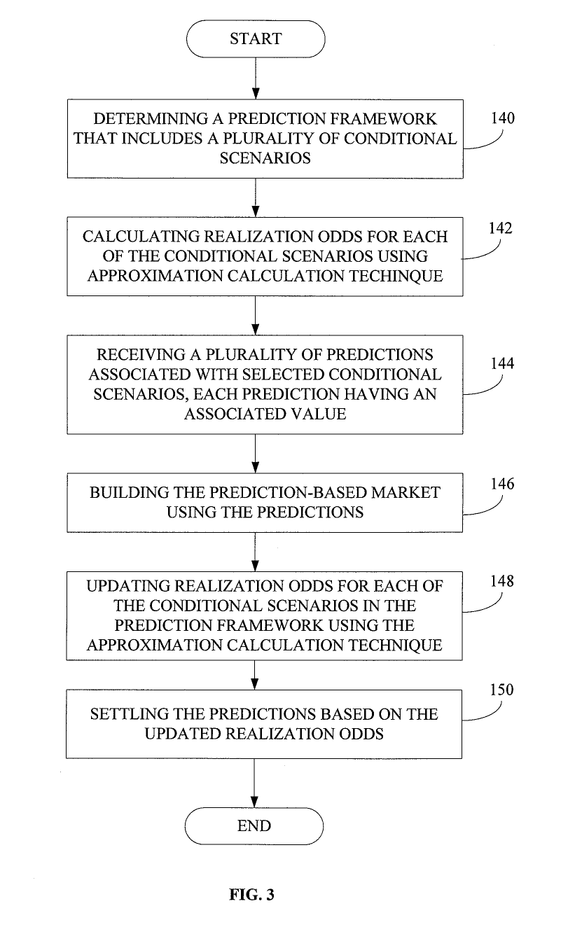

FIG. 3 illustrates a flowchart of the steps of one embodiment of a method for making a prediction-based market including unconventional prediction options to market participants. This method may be performed by the processing device 102 in response to executable instructions received from the storage device 104. The interactions may be facilitated by the web server 124 to the users 126 and the users' computers 128 across the Internet 130 as illustrated in FIG. 2.

A first step of the method includes determining a prediction framework that includes a plurality of conditional scenarios. The prediction framework refers to the overall area in which the predictions are to be based. For example, one particular type of prediction framework may be a sporting event, such as college basketball tournament. The determination includes determining the various conditional scenarios that are available, including conventional scenarios common to basic prediction techniques, for example Team A beats Team B, as well unconventional scenarios such as for example if Team A plays and defeats Team C in a subsequent round of the tournament.

As described in further detail below, the calculations allow for the determination of corresponding odds. If these calculations are performed without approximations, the determination may include restrictions on the number of predictions that can be performed by the user. By contrast, if the calculations are performed with approximations, the prediction market can allow predictions ranging with unlimited prediction options. In one embodiment, the availability of prediction options that users may actually select may be the limited by ability of interfacing options allowing for users 126 to formulate such predictions in a manner consistent with managing a prediction market.

Another example of a prediction-based market may be a political activity, such as an election, such as making a prediction as the outcome of the election itself. Another example may be a security or other type of financial instrument, such as predictions to fluctuations in the values of the instruments.

A next step, step 142, in this method and operation as may be performed by the processing device 102, is the calculation of realization odds for a given one of the conditional scenarios using approximation calculation technique. These calculations are performed based on corresponding equations described in significant detail below.

A next step, 144, is receiving a plurality of predictions associated with selected conditional scenarios, a given prediction having an associated value. These predictions may be received via a user interface with a user 126 entering prediction information on the user's computer 128, the information being communicated across the Internet 130 to the server 124.

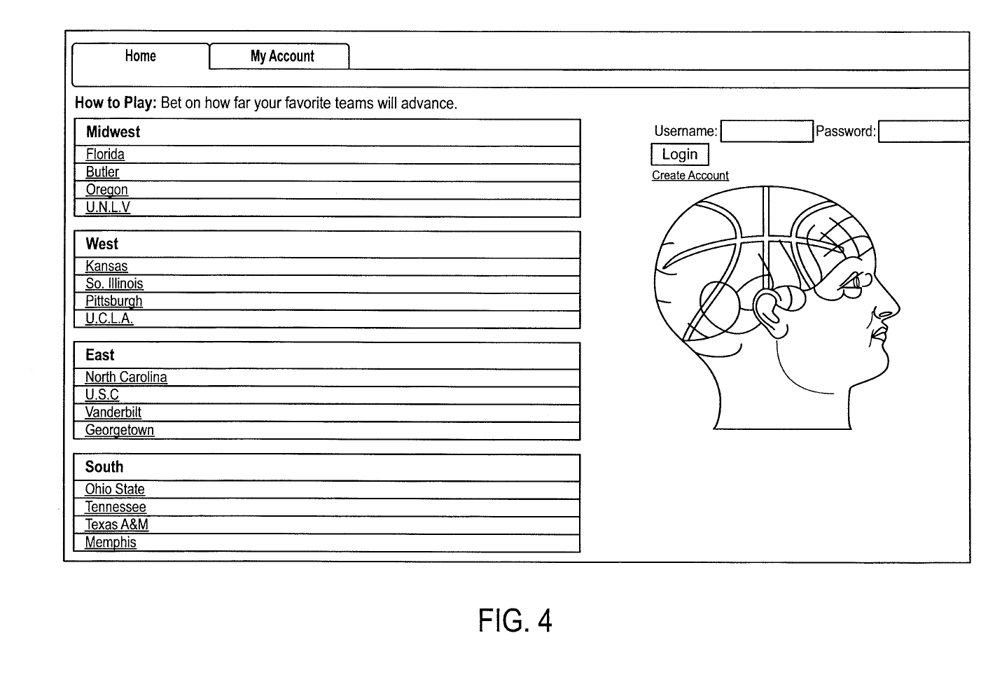

FIG. 4 illustrates an exemplary screenshot of a prediction market for the exemplary embodiment of a basketball tournament, where the prediction market includes the ability to make predictions on how far a particular team will make it in the tournament. This prediction option is in comparison to the typical team A vs. team B prediction options, where previous prediction systems fail to include calculation abilities to formulate the appropriate realization odds for unconventional predictions.

Through the user interface, such as the exemplary interface in FIG. 4, the user may select a particular team. It is also noted that a user may log in to the interface, such as the processing device 102 accessing account data 122 (of FIG. 2) as appropriate.

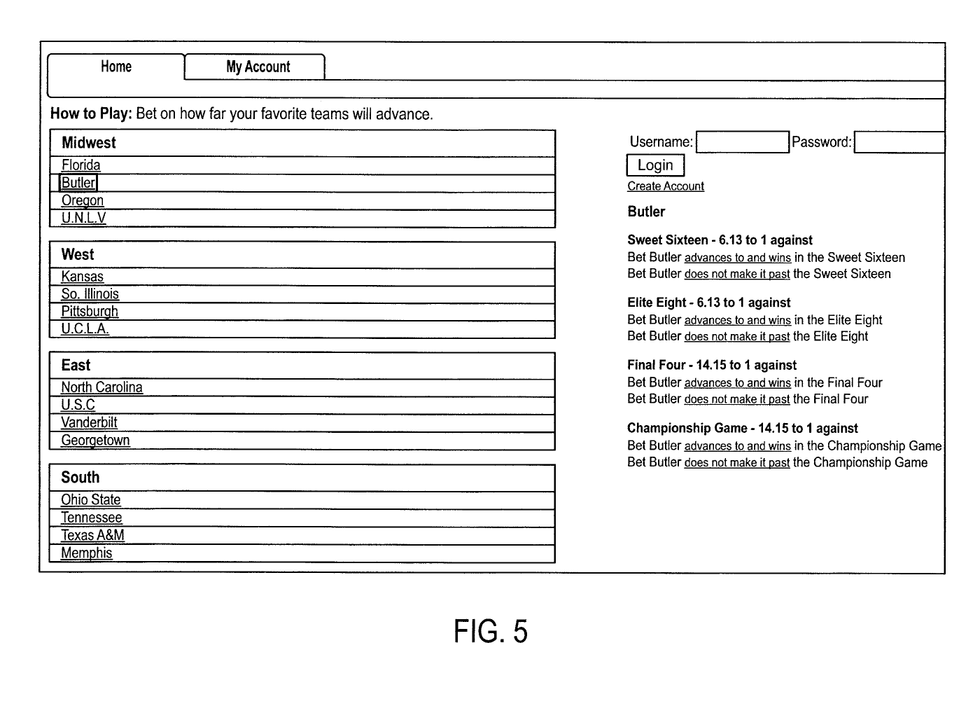

In the exemplary display, FIG. 5 illustrates a screen shot of a secondary interface screen where the user selected college basketball team Butler. This screen shot illustrates the corresponding realization odds for the various rounds, herein described in the common vernacular relative to the NCAA Basketball tournament, the “Sweet Sixteen,” “Elite Eight,” “Final Four” and the championship game. The interface provides the user with additional options for a given one of the specific rounds, in this example being that Butler advances to and wins in the particular round and the other option being that Butler does not make it past this round.

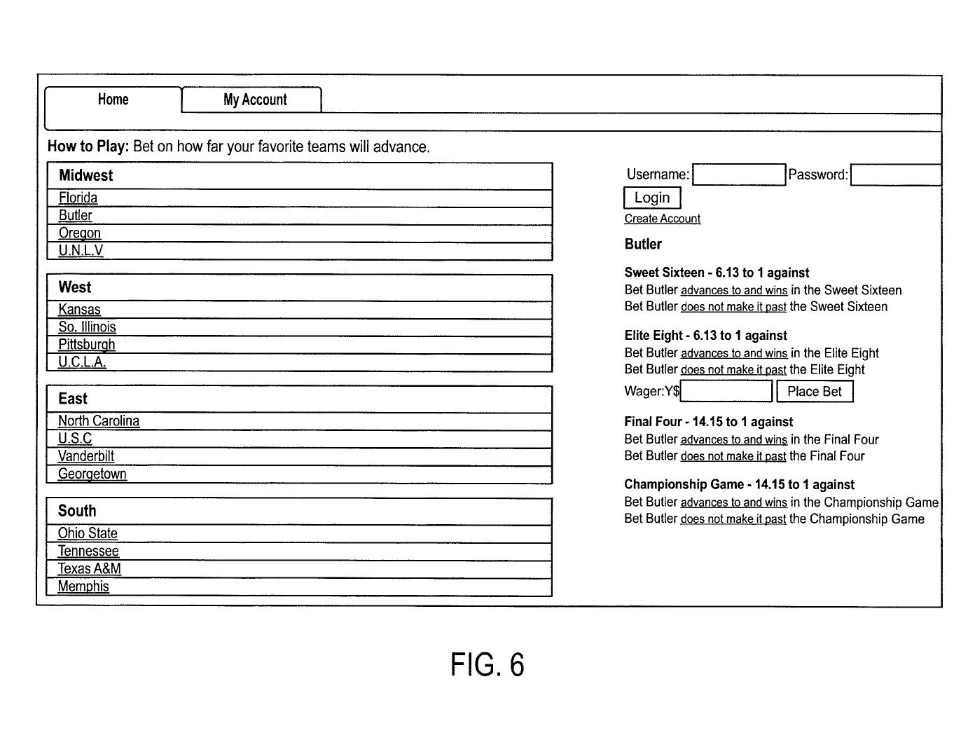

In the exemplary display, FIG. 6 illustrates a screen shot if the user selected the prediction option that Butler does not make it past the Elite Eight round. This interface further includes allowing the user to enter an associated value of the prediction, which in this case is a dollar amount. It is recognized that other denominations or other forms of currency may also readily be used and is not specifically restrict to money.

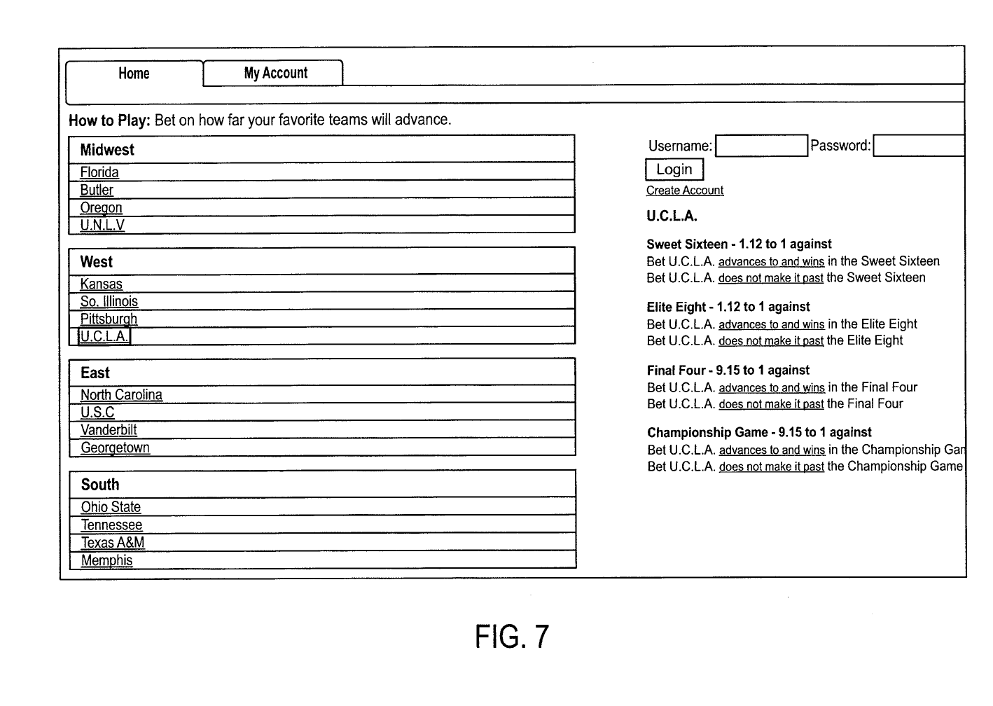

For further illustration, FIG. 7 illustrates another screen shot of the exemplary interface display, wherein the user can select a different team, in this example being U.C.L.A. Similar to FIG. 5, the user is then presented with various odds for selectable scenarios, to which the user can then present a value associated with a predicted outcome.

Referring back to FIG. 3, the method further includes building the prediction-based market using the predictions, step 146. The prediction market is assembled based on multiple predictions by any number of users. The larger the number of users, the more fluid the market can be in responding to realization odds.

Therefore, the next step, step 148 is updating the realization odds for a given one of the conditional scenarios in the prediction framework using the approximation calculation technique. As described below, iterative prediction by various users can cause the realization odds to be adjusted, providing varying odds at various times. In the example of a sporting event, if a large percentage of users predict one time versus another, the odds may then be adjusted to offset this factor.

In this embodiment, a next step, step 150, is settling the predictions based on the updated realization odds. This step may include settling the account after the event has occurred, such as determining what the current realization odds are, factoring the associated value and then either collecting or distributing a corresponding payment. Other embodiments may include a settlement prior to the actual occurrence of the event, for example in the event the realization odds may have adjusted to an extent that the user may then wish to settle the account early. This embodiment may include a certain degree of arbitrage, for example securing a prediction having a first realization odds, then after various users enter subsequent predictions, the users settles based on the different realization odds.

The outcome space Ω for tournaments with n teams can be represented as the set of binary vectors of length n−1, where a given coordinate denotes whether the winner of a game came from the left branch or the right branch of the tournament tree. Then |Ω|=2ⁿ⁻¹ and, in the most general version of the pricing problem, agents are allowed to bet on any of the 2²ⁿ⁻¹ subsets of Ω. The pricing problem is #P-hard, even under certain restrictions on the betting language.

Suppose that there are no outstanding shares when the tournament market opens, and let it be a Bayesian formula. For Sφ={w:w satisfies φ}, |Sφ|=2ⁿ⁻¹(e^{c/b}−1)(e^{1/b}−1) where c is the cost of purchasing 1 share of Sφ and b is the liquidity parameter. The cost of the transaction is denoted by Equation 1.

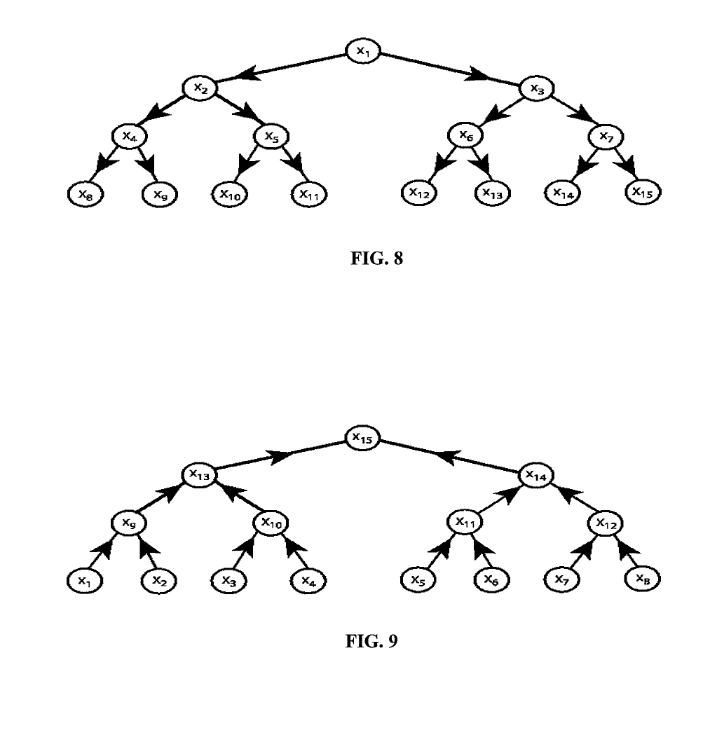

Given that the general pricing problem is #P-hard, restrictions may surround the types of bets agents are allowed to place. The key observation for pricing these assets is that bets in this language preserve the Bayesian network structure depicted in FIG. 8, in which edges are directed away from the final game of the tournament. Surprisingly, these bets do not preserve the Bayesian structure corresponding to the usual understanding of causality in tournaments, in which arrows are reversed. FIG. 8 illustrates a Bayesian network for a tournament. Nodes represent game winners and edges are oriented in reverse of that suggested by the usual notion of causality.

Starting with some preliminary results, equations 2 and 3 show how, in an arbitrary market, probabilities are updated as the result of buying shares on an event. Equation 4 shows how to simplify certain conditional probabilities for a Bayesian network structured as in FIG. 8.

Suppose Δb shares are purchased for the event A, where b is the liquidity parameter. Let P denote the distribution on Ω before the shares are purchased, and let P′ denote the distribution after the purchase. Then, for any event B⊂Q, Equation 2 is as follows:

Suppose Δb shares are purchased for the event A, where b is the liquidity parameter. Let P denote the distribution on Q before the shares were purchased, and let P′ denote the distribution after the purchase. Then, for any events B,C⊂Q, Equation 3 is as follows:

Consider a probability distribution P represented as a Bayesian network on a binary tree with arrows pointing away from the root and nodes labeled as in FIG. 8. Select a node Xi with i>1, and for m<i, let Xi,m be the highest numbered node in {X₁, . . . , Xₘ} that lies along the unique path from the root to Xi. Thus:

Suppose P is represented as a Bayesian network on a binary tree with nodes numbered as in FIG. 8 and arrows pointing away from the root. Consider a market order O=(gⱼ, tⱼ, Δb), interpreted as buying b shares on outcomes in which team tⱼ wins game gⱼ. Then the distribution P′ that results from executing the order is also represented by a Bayesian network with the same structure, and only the distributions of gⱼ and its ancestors are affected. Furthermore, the uniform distribution P₀, corresponding to 0 shares on a given outcome, is represented by the Bayesian network.

Considering the setting of the paragraph above, the Bayesian network representing P is constructed from the Bayesian network representing P as follows: For X_{gj} and one or more of its ancestors, update the conditional probabilities according to Equation 5.

Equation 5 assumes Xi is not the root. Therefore, the update of the unconditional distribution of the root is determined by Eq. 6.

Suppose Δb shares are purchased for the event A, and let P denote the distribution on Ω before the shares are purchased. Then the cost of the purchase is b log (e^{Δ}P(A)+P(Â)).

To support conditional bets, a showing may be made with regard to how to support bets in which agents pick the winners of two games, one of which is the parent game of the other. By combining these securities, one can construct the conditional assets as well.

Suppose P is represented as a Bayesian network on a binary tree with nodes numbered as in FIG. 9 and arrows pointing away from the root. Consider a market order O=(gⱼ₁, tⱼ₁, gⱼ₂, t, Δb), interpreted as buying Δb shares on outcomes in which team tⱼᵢ wins game gⱼᵢ, where gⱼ₁ is the parent of gⱼ₂. Then the distribution P′ that results from executing the order is also represented by a Bayesian network with the same structure, and only the distributions of gⱼ₂ and its ancestors are affected.

Consider the setting of the discussion above, the Bayesian network representing P′ is constructed from the Bayesian network representing P as follows: For X_{gj2} and one or more of its ancestors, update the conditional probabilities according to Equation 7.

Thus, assuming Xi is not root, update the (unconditional) distribution of the root by Equation 8.

The conditional distribution for other nodes remain the same.

Suppose P is represented as a Bayesian network on a binary tree with nodes numbered as in FIG. 7 and arrows pointing away from the root. Set A={Xk=i} and B={Xj=i} where Xⱼ is the child of Xₖ for which B≠Ø. Then the distribution P′ that results from buying Δb shares on ÂB is still represented by a Bayesian network with the same structure. Moreover, only the distributions of Xⱼ and its ancestors are affected, and are updated as indicated in Equation 9.

Thus, assuming Xi is not root, update the (unconditional) distribution of the root by Equation 10.

The conditional distribution for other nodes remain the same.

To construct the conditional asset “team i beats team j given that they face off” observe that there is a unique game k in which i and j could potentially play each other. Set A={Xₖ=i} and B={Xⱼ₁=i, Xⱼ₂=j} where Xⱼ₁ and Xⱼ₂ are the children of Xₖ ordered such that B≠Ø. Now AB={Xₖ=i, Xⱼ₂=j} and AB={Xₖ=j, Xⱼ₁=i}. This allows agents to trade in both of these joint events, and they can consequently construct the conditional asset.

The cost for purchasing Δb shares of A|B is b log e^{Δ}P(A|B)+P(A′|B). Then, if AB occurs, the agent receive Δb dollars; if A′B occurs, the agent receives nothing; and if B does not occur, the agent is returned the cost of the purchase.

For n teams, O(n³) operations are needed to update the Bayesian network as a result of trading assets of the form “team i wins game k”, “team i wins game k given that they make it to that game” and “team i beats team j given they face o.”

The above-described betting language can lead to unexpected dependencies in the market-derived distribution. This phenomenon may be illustrated by way of the following simple example. Suppose there are four teams {T₁, . . . T₄}, so that the tournament consists of three games {X1, X2, X3}, where X2 and X3 are the first round games, and X1 is the final game. The state space Ω has eight outcomes: w1=(1,3,1); w2=(1,3,3); w3=(1,4,1); w4=(1,4,4); w5=(2,3,2); w6=(2,3,3); w7=(2,4,2); and w8=(2,4,4), where a given coordinate indicates which team won the corresponding game.

Suppose a starting point with no outstanding shares, and are to execute two bets: “Δb shares on team 1 to win game 3 and Δb shares on team 3 to win game 3.” After executing these bets, outcomes w1, w2, w3 and w6 have Δb shares, and the other outcomes have 0 shares. Therefore, as illustrated in Equation 11:

Additionally, P(X₁=1, X₂=3)=2e^{Δ}(4e^{Δ}+4). In particular, since P(X₁=1) P(X₂=3)≠P(X₁=1, X₂=3), X₁ and X₂ are not independent.

Here the betting language may be further restricted so as to preserve the usual independence relations. The language allows only bets of the form “team i beats team j given that they face off.” These bets preserve the Bayesian network structure shown in FIG. 8. Notably, the edges in the network are directed toward the final game of the tournament, in contrast to the Bayesian network representing our more expressive language. In particular, the conditional distribution of a game Xⱼ given previous games depend only on the two games X^{L}ⱼ and X^{R}ⱼ directly leading up to Xⱼ, as one might ordinarily expect to be the case.

Suppose P is represented as a Bayesian network on a binary tree with nodes numbered as in FIG. 9 and arrows pointing toward the root. Consider a market order O=(gⱼ, tⱼ, t′ⱼ, Δb), interpreted as buying Δb shares on outcomes in which team tⱼ wins game gⱼ, conditional on tⱼ and t′ⱼ playing in game gⱼ. Then the distribution P′ that results from executing the order is also represented by a Bayesian network with the same structure, and only the distribution of gⱼ is affected. Furthermore, the uniform distribution P₀, corresponding to 0 shares on a given outcome, is represented by the Bayesian network.

The Bayesian network representing P is constructed from the Bayesian network representing P as follows: For A={X_{gj}=tⱼ} and B={{X^{L}_{gj}, X^{R}_{gj}=tⱼ, t′ⱼ}}, update the conditional probability P′(A|B) according to Equation 12.

Furthermore, set P(A|B)=1−P′(A|B)). Other conditional probabilities remain unchanged.

One or more pair of teams play each other in at most one game, namely in the game that is their nearest common descendent in the tournament tree. One can think of this betting language as maintaining

$$( \begin{matrix}n \\ 2\end{matrix} )$$

independent markets, one for a given pair of teams, where a given market provides an estimate of a particular team winning given they face off. Although bets in one market do not affect prices in any other market, they do effect the global distribution on Ω. In particular the distribution on Ω is constructed from the independent markets via the Bayesian network.

Since a given trade in this language involves updating only a single parameter of the Bayesian network, and since that update can be performed in O(n) steps, the execution time for trades is linear with regard to the number of teams.

The general problem of pricing combinatorial markets is #P-hard. As described above, it is shown how to compute asset prices for an expressive betting language for tournaments. Although, additionally it is applicable in some embodiments to perform computations using an approximation technique. As noted above, the approximation technique provides for a larger degree or variety of prediction options.

As market-maker, one objective is to compute P_{q}(A) where P_{q} is the probability distribution over Ω corresponding to outstanding shares q and A is an arbitrary event. Equivalently, E_{Pq}I_{A} where I_{A}(w)=1 is computed if w is in the set of A and I_{A}(w)=0 otherwise. One can approximate this expectation by the unbiased estimator based on Equation 13.

In Equation 13, Xi˜Pq, e.g., Xi are draws from Pq. Since, generally speaking, it is not reasonable to expect to be able to generate such draws, the calculations rely on importance sampling. The simple insight behind importance sampling is that for any measure μ>>Pq:

Consequently, one can approximate Pq(A) by the unbiased estimator of Equation 15.

In Equation 15, Xi˜μ, e.g., Xi are draws from μ. One embodiment includes the application of an asymptotically unbiased estimator, such as Eq. 16.

The considerable advantage of Equation 16 is that the importance weights Pq(Xi)/μ(Xi) only need to be known up to a constant. For example, suppose we are able to draw uniformly from Ω, e.g., μ(w)=1/N where |Ω|=N. Then the importance weights satisfy Equation 17.

For a constant Z, Equation 16 simplifies to Equation 18.

In the above, it is assumed that μ is to be uniform over Ω. In some cases, it may be possible to make draws from Ω according to Equation 19.

In Equation 19, Z′ is the total number of shares on Ω. A given market order Oi=(Aᵢ, sᵢ) consists of an event Aᵢ and the number of shares sᵢ to buy on that event. Suppose that for a given set corresponding to an order, its size nᵢ may be computed and an outcome from Aᵢ may be chosen uniformly at random. Choose an outcome from Ω as follows: (1) select an order Oᵢ at random proportional to nᵢsᵢ; and (2) select an outcome from Oᵢ at random.

FIGS. 1 through 9 are conceptual illustrations allowing for an explanation of the present invention. It should be understood that various aspects of the embodiments of the present invention could be implemented in hardware, firmware, software, or combinations thereof. In such embodiments, the various components and/or steps would be implemented in hardware, firmware, and/or software to perform the functions of the present invention. That is, the same piece of hardware, firmware, or module of software could perform one or more of the illustrated blocks (e.g., components or steps).

In software implementations, computer software (e.g., programs or other instructions) and/or data is stored on a machine readable medium as part of a computer program product, and is loaded into a computer system or other device or machine via a removable storage drive, hard drive, or communications interface. Computer programs (also called computer control logic or computer readable program code) are stored in a main and/or secondary memory, and executed by one or more processors (controllers, or the like) to cause the one or more processors to perform the functions of the invention as described herein. In this document, the terms memory and/or storage device may be used to generally refer to media such as a random access memory (RAM); a read only memory (ROM); a removable storage unit (e.g., a magnetic or optical disc, flash memory device, or the like); a hard disk; electronic, electromagnetic, optical, acoustical, or other form of propagated signals (e.g., carrier waves, infrared signals, digital signals, etc.); or the like.

Notably, the figures and examples above are not meant to limit the scope of the present invention to a single embodiment, as other embodiments are possible by way of interchange of some or all of the described or illustrated elements. Moreover, where certain elements of the present invention can be partially or fully implemented using known components, only those portions of such known components that are necessary for an understanding of the present invention are described, and detailed descriptions of other portions of such known components are omitted so as not to obscure the invention. In the present specification, an embodiment showing a singular component should not necessarily be limited to other embodiments including a plurality of the same component, and vice-versa, unless explicitly stated otherwise herein. Moreover, applicants do not intend for any term in the specification or claims to be ascribed an uncommon or special meaning unless explicitly set forth as such. Further, the present invention encompasses present and future known equivalents to the known components referred to herein by way of illustration.

The foregoing description of the specific embodiments so fully reveal the general nature of the invention that others can, by applying knowledge within the skill of the relevant art(s) (including the contents of the documents cited and incorporated by reference herein), readily modify and/or adapt for various applications such specific embodiments, without undue experimentation, without departing from the general concept of the present invention. Such adaptations and modifications are therefore intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance presented herein, in combination with the knowledge of one skilled in the relevant art(s).

While various embodiments of the present invention have been described above, it should be understood that they have been presented by way of example, and not limitation. It would be apparent to one skilled in the relevant art(s) that various changes in form and detail could be made therein without departing from the spirit and scope of the invention. Thus, the present invention should not be limited by any of the above-described exemplary embodiments, but should be defined only in accordance with the following claims and their equivalents.

What is claimed is:

1. A method for making a prediction-based market including unconventional prediction options to market participants, the method comprising:
determining a prediction framework that includes a plurality of conditional scenarios;
calculating realization odds for each of the conditional scenarios using an approximation calculation technique;
via an interface, receiving a plurality of predictions associated with selected conditional scenarios, each prediction having an associated value;
building the prediction-based market using the predictions;
updating realization odds for each of the conditional scenarios in the prediction framework using the approximation calculation technique; and
settling the predictions based at least on the updated realization odds.

2. The method of claim 1 further comprising:
settling the predictions based on the realization odds, an outcome of the conditional scenario and the associated value.

3. The method of claim 1 wherein the prediction framework includes unrestricted conditional scenarios based on the approximation calculation technique.

4. The method of claim 1, wherein the prediction framework relates to a sporting event.

5. The method of claim 4, wherein the conditional scenarios relate to secondary or tertiary round match-ups between sporting event participants and the realization odds are based at least on primary round events.

6. The method of claim 1, wherein the prediction framework relates to a financial event.

7. The method of claim 1, wherein the prediction framework relates to a political event.

8. The method of claim 1 including settling the predictions prior to the occurrence of the condition based on the updated realization odds.

9. The method of claim 1, wherein settling the prediction includes at least one of: crediting a users account if credit is owed and debiting a user account if a debt is owed.

10. The method of claim 9, wherein the settlement includes the crediting or debiting of legal tender.

11. An apparatus for making a prediction-based market including unconventional prediction options to market participants, the apparatus comprising:
a computer readable medium having executable instructions stored thereon; and
a processing device, in response to the executable instructions, operative to:
determine a prediction framework that includes a plurality of conditional scenarios;
calculate realization odds for each of the conditional scenarios using an approximation calculation technique;
via an interface, receive a plurality of predictions associated with selected conditional scenarios, each prediction having an associated value;
build the prediction-based market using the predictions;
update realization odds for each of the conditional scenarios in the prediction framework using the approximation calculation technique; and
settle the predictions based at least on the updated realization odds.

12. The apparatus of claim 11, the processing device further operative to:
settle the predictions based on the realization odds, an outcome of the conditional scenario and the associated value.

13. The apparatus of claim 11 wherein the prediction framework includes unrestricted conditional scenarios based on the approximation calculation technique.

14. The apparatus of claim 11, wherein the prediction framework relates to a sporting event.

15. The apparatus of claim 14, wherein the conditional scenarios relate to secondary or tertiary round match-ups between sporting event participants and the realization odds are based at least on primary round events.

16. The apparatus of claim 11, wherein the prediction framework relates to at least one of: a financial event and a political event.

17. The apparatus of claim 11 wherein the processing device is further operative to settle the predictions prior to the occurrence of the condition based on the updated realization odds.

18. The apparatus of claim 11, wherein the processing device is further operative, when settle to include at least one of: crediting a users account if credit is owed and debiting a user account if a debt is owed.

19. The apparatus of claim 18, wherein the settlement includes the crediting or debiting of legal tender.

20. A computer readable medium having executable instructions for making a prediction-based market including unconventional options to market participants, the instructions stored thereon, wherein when the executable instructions are read by a processing device, the processing device is operative to:
determine a prediction framework that includes a plurality of conditional scenarios;
calculate realization odds for each of the conditional scenarios using an approximation calculation technique;
via an interface, receive a plurality of predictions associated with selected conditional scenarios, each prediction having an associated value;
build the prediction-based market using the predictions;
update realization odds for each of the conditional scenarios in the prediction framework using the approximation calculation technique; and
settle the predictions based at least on the updated realization odds.
